(19) United States
(12) Patent Application Publication
(10) Pub. No.: US 2019/0309097 A1
(43) Pub. Date: Oct. 10, 2019

(54) ASYMMETRIC COMPOUNDS CARRYING BINDING GROUPS

(71) Applicant: Arkema France, Colombes (FR)

(72) Inventors: Jean-Luc COUTURIER, Lyon (FR); Jean-Francois DEVAUX, Soucieu en Jarrest (FR); Manuel HIDALGO, Brignais (FR)

(73) Assignee: Arkema France, Colombes (FR)

(21) Appl. No.: 16/340,698

(22) PCT Filed: Oct. 11, 2017
(86) PCT No.: PCT/FR2017/052803

§ 371 Date: Apr. 10, 2019

(30) Foreign Application Priority Data
Oct. 12, 2016 (FR) 1659878

(51) Int. Cl. C08C 19/25; C07F 7/18; B29B 11/10; B60C 1/00

(52) U.S. Cl. CPC C08C 19/25; C07F 7/1804; B29K 2021/00; B29B 11/10; B60C 1/0016; C07F 7/1888

(57) ABSTRACT

The invention relates to a compound of formula (I), wherein: A represents a binding group comprising at least one nitrogen atom; Q₁ and Q₂ represent, independently of one another, a linkage group; x is an integer between 2 and 6; and Z represents the group of formula (I), wherein each R′ represents, independently, an alkyl group having between 1 and 4 carbon atoms. The invention also relates to a rubber composition comprising said compound.

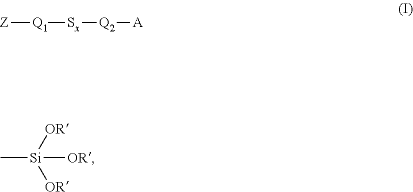

### FIELD OF THE INVENTION

The present invention relates to novel compounds that can be used as modifying agents in rubber compositions, to processes for producing same, and also to novel rubber compositions comprising these compounds.

### TECHNICAL BACKGROUND

In the industrial field of items produced from rubber compositions, and in particular tires, mixtures of polymers with fillers are often used. In order for such mixtures to have good properties, means for improving the dispersion of the fillers in the polymers are constantly being sought. One of the means for achieving this result is the use of coupling agents capable of establishing interactions between the polymer and the filler.

For example, documents FR 2149339 and FR 2206330 describe sulfur-containing compounds comprising two organosilicon end groups, used as coupling agent.

Document WO 2012/007684 describes coupling agents comprising a nitrogenous associative group and a nitrogenous dipole.

However, these compounds have drawbacks: they are obtained by multistep synthesis, typically in five steps, and are very expensive to produce. Furthermore, some raw materials required to produce them, such as mesitol or dichloromethyl methyl ether, are not readily commercially available on a large scale.

Polysulfides comprising a trialkoxysilyl group and a nitrogenous function without a bonding group between the nitrogenous function and the polysulfide function have also been described.

For example, document US 2006/086450 describes vulcanizable elastomeric compositions comprising silica-coupling agents, in particular bis(trialcoxysilylorgano) polysulfides, mercaptosilanes and blocked mercaptosilanes.

However, the groups comprising a trialkoxysilyl group and a nitrogenous function without a bonding group between the nitrogenous function and the polysulfide function are either too stable at the level of the bonding between the nitrogenous function and the polysulfide function, or not stable enough. Moreover, the proximity between the polysulfide function and the nitrogenous function does not allow filler-polymer coupling by this part of the molecule.

Document CN 102491344 describes the synthesis of silica nanoparticles, the surface of which is functionalized with a sulfhydryl benzimidazole disulfide group.

The document “Multifunctional Envelope-Type Mesoporous Silica Nanoparticles for Tumor-Triggered Targeting Drug Delivery”, Jing Zhang et al., J. Am. Chem. Soc., 2013, vol. 135, pp 5068-5073, describes functionalized mesoporous silica nanoparticles. The silica nanoparticles are first functionalized by means of 3-mercaptopropyltrimethoxysilane and then by means of S-(2-aminoethylthio)-2-thiopyridine and finally by various other steps.

The document “Tuning kinetics of controlled-release in disulfide-linked MSN-folate conjugates with different fabrication procedures”, Rui Guo et al., Material Letters, 2012, vol. 66, pp 79-82, describes mesoporous silica nanoparticles functionalized with folic acid via a disulfide group.

In the three documents above, the polysulfide compounds described have an oxysilane group bonded to a silica nanoparticle.

There is a real need to provide compounds obtained in few steps, with good yields, from inexpensive and readily available raw materials, these compounds ensuring a good interaction between the polymers and fillers, that is to say making it possible to obtain rubber compositions with good mechanical properties and good wear resistance. There is also a need to provide compounds which make it possible to obtain rubber compositions with hysteresis that is as low as possible, in order to be able to easily use them and to obtain tires which have reduced rolling resistance.

### SUMMARY OF THE INVENTION

The invention relates first and foremost to a compound of formula (I)

Z-Q₁-Sₓ-Q₂-A (I)

wherein:
A represents an associative group comprising at least one nitrogen atom,
Q₁ and Q₂ represent, independently of one another, a bonding group,
x is an integer ranging from 2 to 6, and
Z represents the group:

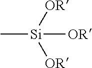

wherein each R′ independently represents an alkyl group comprising from 1 to 4 carbon atoms.

According to one embodiment, A is chosen from imidazolidinone, triazoyl, ureyl, bisureyl and ureidopyrimidyl groups.

According to one embodiment, A corresponds to one of the following formulae (II) to (VI):

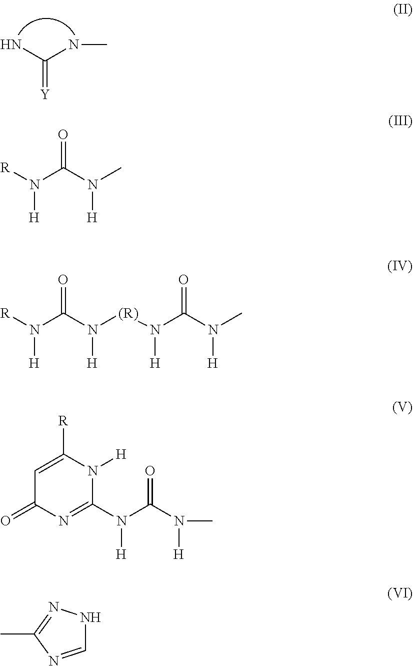

where:
R denotes a hydrocarbon-based group which may optionally contain heteroatoms,
Y denotes an oxygen or sulfur atom, preferably an oxygen atom.

According to one embodiment, A is a group of formula (VII):

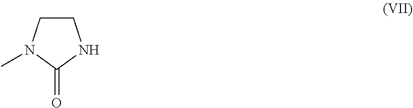

According to one embodiment, Q₁ and Q₂ are independently a linear or branched, substituted or unsubstituted, divalent C₁-C₂₄, preferably C₁-C₁₀, hydrocarbon-based radical, optionally interrupted and/or substituted with one or more nitrogen or oxygen atoms, and more preferentially an uninterrupted and unsubstituted divalent C₁-C₆ hydrocarbon-based radical; Q₁ and Q₂ preferably being identical.

According to one embodiment, x is equal to 4.

According to one embodiment, all the R′ are identical in the Z group, and, preferably, each R′ is the ethyl group.

According to one embodiment, the compound is of formula (VIII) below:

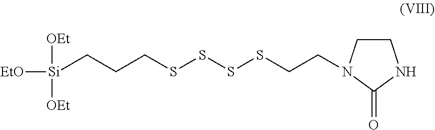 [SMILES: CCO[Si](CCCSSSSCCN1CCNC1=O)(OCC)OCC]

The invention also relates to a mixture of various compounds of formula (I)

Z-Q₁-Sₓ-Q₂-A (I)

wherein:
A represents an associative group comprising at least one nitrogen atom,
Q₁ and Q₂ represent, independently of one another, a bonding group,
x is an integer ranging from 2 to 6, and
Z represents the group:

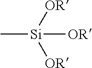

wherein each R′ independently represents an alkyl group comprising from 1 to 4 carbon atoms;
the compounds having different values of x and otherwise being identical, wherein x has an average value of between 2 and 6.

The invention also relates to a composition comprising a compound of formula (I) as defined above, and also the compounds of formulae (I′) and (I″) below:

A-Q₁-Sₓ-Q₂-A (I′)

Z-Q₁-Sₓ-Q₂-Z (I″)

wherein A, Z, Q₁, Q₂ and x have the same meaning as in formula (I).

The invention also relates to a process for producing a compound of formula (I) as defined above, comprising a step of reacting a sulfur-containing compound with a compound of formula (IX)

X₁-Q₁-Z (IX)

and a compound of formula (X)

X₂-Q₂-A (X),

wherein
A, Z, Q₁ and Q₂ have the meanings defined above, and
X₁ and X₂ independently represent a Cl atom or an SH group.

According to one embodiment, X₁ and X₂ each represent a Cl atom.

According to one embodiment, the sulfur-containing compound is sodium tetrasulfide, the compound produced being of formula (I) with x=4; and
preferably, A is a group of formula (VII):

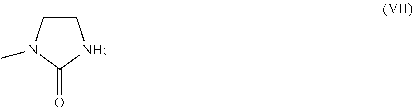

and/or
preferably, Q₁ and Q₂ independently represent a divalent C₁-C₆ hydrocarbon-based radical, more preferentially a divalent C₂ hydrocarbon-based radical; and/or
preferably, all the R′ groups in the Z group are ethyl groups.

According to one embodiment, the sulfur-containing compound is sulfur, X₁ is an SH group and X₂ is a Cl group or vice versa, and:
preferably, A is a group of formula (VII):

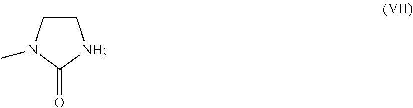

and/or
preferably, Q₁ and Q₂ independently represent a divalent C₁-C₆ hydrocarbon-based radical, more preferentially a divalent C₂ hydrocarbon-based radical; and/or
preferably, all the R′ groups in the Z group are ethyl groups; and/or
preferably, X₁ represents SH and X₂ represents Cl.

The invention also relates to a process for producing a compound of formula (I) as defined above, comprising a step of reacting, in the presence of a base, a compound of formula (I′) with a compound of formula (I″):

A-Q₁-Sₓ-Q₂-A (I′)

Z-Q₁-Sₓ-Q₂-Z (I″)

wherein A, Z, Q₁, Q₂ and x have the same meaning as in formula (I).

According to one embodiment:
preferably, A is a group of formula (VII):

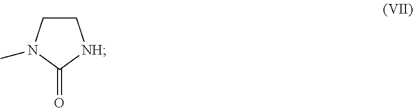

and/or
preferably, Q₁ and Q₂ independently represent a divalent C₁-C₆ hydrocarbon-based radical, more preferentially a divalent C₂ hydrocarbon-based radical; and/or
preferably, all the R′ groups in the Z group are ethyl groups; and/or
preferably, the base is a sodium alkoxide, more particularly preferably sodium methoxide or sodium ethoxide.

The invention also relates to a rubber composition comprising at least one diene elastomer, a reinforcing filler, a chemical crosslinking agent and a modifying agent, optionally already grafted onto the elastomer, said modifying agent being a compound of formula (I) as defined above or a mixture as defined above.

According to one embodiment, the diene elastomer comprises an essentially unsaturated diene elastomer chosen from natural rubber, synthetic polyisoprenes, polybutadienes, butadiene copolymers, isoprene copolymers and blends thereof; and/or comprises an essentially saturated elastomer chosen from butyl rubbers, diene/alpha-olefin copolymers such as EPDM, and blends thereof.

According to one embodiment, the chemical crosslinking agent comprises from 0.5 to 12 phr of sulfur, preferably from 1 to 10 phr of sulfur, or from 0.01 to 10 phr of one or more peroxide compounds.

According to one embodiment, the modifying agent content ranges from 0.01 to 50 mol %, preferably from 0.01 mol % to 5 mol %.

The invention also relates to a process for producing a rubber composition as defined above, comprising one or more steps of thermomechanical kneading of the diene elastomer, the reinforcing filler, the chemical crosslinking agent and the modifying agent, and an extruding and calendering step.

The invention also relates to an item produced entirely or partly with a rubber composition as defined above, preferably chosen from leaktight seals, thermal or acoustic insulators, cables, sheaths, footwear soles, packagings, coatings (paints, films, cosmetic products), patches (cosmetic or dermopharmaceutical), other systems for trapping and releasing active agents, dressings, elastic clamp collars, vacuum pipes, and pipes and flexible tubing for the transportation of fluids.

The invention also relates to a tire comprising a rubber composition as defined above.

The invention also relates to a modified polymer obtained by grafting a compound of formula (I) as defined above or a mixture thereof as defined above.

According to one embodiment, the polymer is a diene elastomer, preferably an essentially unsaturated diene elastomer chosen from natural rubber, synthetic polyisoprenes, polybutadienes, butadiene copolymers, isoprene copolymers and blends of these elastomers, or an essentially saturated elastomer chosen from butyl rubbers, diene/alpha-olefin copolymers such as EPDM, and blends thereof.

The invention also relates to a process for producing a modified polymer, comprising a step of grafting a compound of formula (I) as defined above, or a mixture as defined above, onto a polymer comprising at least one unsaturation.

The present invention makes it possible to overcome the disadvantages of the prior art. It more particularly provides compounds of formula (I) which make it possible to obtain rubber compositions which both have improved properties and a reduced production cost.

The compounds of formula (I) can be produced in few steps, for example from two to four steps, some of which can be carried out in one and the same reactor, and starting from inexpensive raw materials.

Advantageously, the invention makes it possible to obtain rubber compositions which have effective mechanical properties and good wear resistance.

Likewise advantageously, the invention makes it possible to obtain rubber compositions which have low hysteresis and high rigidity at medium stresses, while the same time exhibiting a high elongation at break or a high tensile strength. These rubber compositions make it possible to obtain tires which have reduced rolling resistance.

Without wanting to be bound by any theory, the inventors consider that the compounds according to the invention comprise both a silane function capable of reacting for example with a filler (for example a siliceous filler) so as to form covalent bonds, and an associative group capable of forming noncovalent bonds (for example hydrogen bonds) with a filler such as a siliceous filler. These bonds are possible because the polysulfide function and the silane and associative functions are spaced out by inert bonding groups. The simultaneous presence of strong and weak bonds is capable of conferring advantageous mechanical properties on the rubber composition, such as, for example, better dispersion of the filler than with the prior art compounds comprising only silane functions, and less wear than with the prior art compounds comprising only associative groups.

### DESCRIPTION OF EMBODIMENTS OF THE INVENTION

The invention is now described in greater detail and in a nonlimiting manner in the description which follows.

### Compounds of Formula (I)

The invention relates to a compound of formula (I):

Z-Q₁-Sₓ-Q₂-A (I)

wherein S is a sulfur atom, x is an integer, A represents an associative group comprising at least one nitrogen atom, Q₁ and Q₂ are bonding groups and Z represents the trialkoxysilane group:

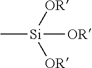

wherein each R′ independently represents an alkyl group comprising from 1 to 4 carbon atoms.

The term “associative groups” is intended to mean groups capable of associating with one another via hydrogen, ionic and/or hydrophobic bonds. According to one preferred embodiment of the invention, they are groups capable of associating via hydrogen bonds.

When the associative groups are capable of associating via hydrogen bonds, each associative group preferably comprises at least one donor “site” and one acceptor site with respect to the hydrogen bond, such that two identical associative groups are self-complimentary and can associate with one another by forming at least two hydrogen bonds.

The associative groups according to the invention are also capable of associating, via hydrogen, ionic and/or hydrophobic bonds, with functions present on fillers.

According to one particular embodiment of the invention, the A group is chosen from imidazolidinone, ureyl, bisureyl, ureidopyrimidyl and triazolyl 1 groups.

Preferably, the associative group A corresponds to one of the following formulae (II) to (VI):

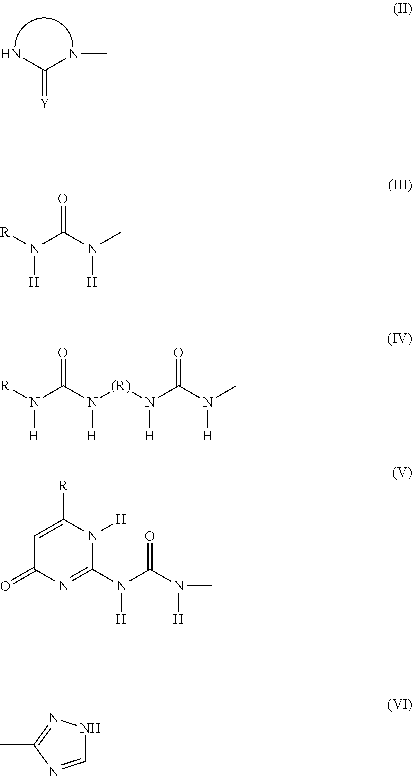

where:
R denotes a linear, branched or cyclic (preferably linear) (preferably C₁-C₁₀, even more preferentially C₁-C₆) hydrocarbon-based group which may optionally contain heteroatoms (and preferably contains no heteroatoms),
Y denotes an oxygen or sulfur atom, preferably an oxygen atom.

In formula (II), the two nitrogen atoms are linked by a divalent organic group, for instance a hydrocarbylene group, such as an alkylene, a substituted alkylene, a cycloalkylene, a substituted cycloalkylene, an arylene or a substituted arylene. The hydrocarbylene group contains from 1 to 10 carbon atoms. The hydrocarbylene group may also contain heteroatoms such as nitrogen, oxygen or sulfur. These heteroatoms may be included in the hydrocarbylene chain or may replace a carbon. Particularly preferably, the group of formula (II) comprises 5 or 6 atoms.

Preferably, the A group is a di- or trinitrogenous heterocycle comprising 5 or 6 atoms, preferably dinitrogenous, and comprising at least one carbonyl function.

Even more preferably, the A group is the imidazolidinone group of formula (VII):

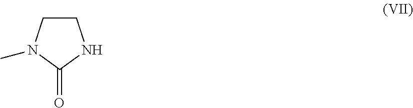

The bonding groups Q₁ and Q₂ may be any divalent radical. They are preferably chosen so as to interfere little or not at all with the associative group A and with the trialkoxysilane group Z.

Said Q₁ and Q₂ groups are then in particular considered to be inert groups with respect to the associative group A. The term “inert group with respect to the associative group A” is intended to mean a group which does not comprise associative functions as defined according to the invention. They are then also considered to be inert groups with respect to the trialkoxysilane group Z, that is to say that they are not capable of forming a covalent bond with such a group (located on another molecule of the compound).

The Q₁ and Q₂ groups are preferably independently a linear, branched or cyclic, divalent hydrocarbon-based radical. They may independently contain one or more aromatic radicals, and/or one or more heteroatoms. The divalent hydrocarbon-based radical may optionally be substituted, the substituents preferably being inert with respect to the associative group A and to the trialkoxysilane group Z.

According to one preferred embodiment, the Q₁ and Q₂ groups are independently a linear or branched, substituted or unsubstituted, divalent C₁-C₂₄, preferably C₁-C₁₀, hydrocarbon-based radical, optionally interrupted and/or substituted with one or more nitrogen or oxygen atoms, and more preferentially an uninterrupted and unsubstituted divalent C₁-C₆ hydrocarbon-based radical, and more particularly preferably linear.

Q₁ and Q₂ may be different or identical, but preferably Q₁ and Q₂ are identical.

In formula (I) above, x is an integer ranging from 2 to 6.

According to particular embodiments, x is an integer ranging from 2 to 5, or x is an integer ranging from 2 to 4, or x is an integer ranging from 3 to 5, or x is an integer equal to 2 or 3, or x is an integer equal to 3 or 4.

According to other particular embodiments, x is equal to 2 or 3 or 4 or 5 or 6.

The R′ groups in the alkoxysilane compound Z may preferably be methyl, ethyl, propyl, isopropyl or butyl groups. Ethyl groups are preferred. All the R′ groups are preferably identical.

According to one embodiment, the compound of the invention is chosen from the compounds of formula (VIII) below:

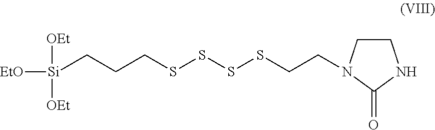 [SMILES: CCO[Si](CCCSSSSCCN1CCNC1=O)(OCC)OCC]

The invention also relates to mixtures of various compounds of formula (I) with various values of x (the compounds being otherwise identical). For example, the invention relates to mixtures of compounds of formula (I) with x ranging from 2 to 6, or from 2 to 5, or from 2 to 4, the compounds being otherwise identical. Such a mixture can be considered to be a compound of formula (I) with x having a certain statistical distribution and in particular an average value which is not necessarily a whole number, and which is between 2 and 6 (preferably between 2 and 5, more particularly preferably between 2 and 4).

In particular, certain production processes described below result in the production of such compound mixtures.

The invention also relates to a mixture of compounds of formula (I) with the following symmetrical compounds of formulae (I′) and (I″):

A-Q₁-Sₓ-Q₂-A (I′)

Z-Q₁-Sₓ-Q₂-Z (I″)

wherein A, Z, Q₁, Q₂ and x have the same meaning as in formula (I).

In particular, certain production processes described below result in the production of such mixtures of asymmetrical compounds (according to formula (I)) and symmetrical compounds (according to formulae (I′) and I″)).

The invention also relates to mixtures of compounds of formulae (I), (I′) and (I″) with various values of x (the compounds being otherwise identical), in particular with x ranging from 2 to 6, or from 2 to 5, or from 2 to 4, and having an average value, which is not necessarily a whole number, between 2 and 6, or between 2 and 5, or between 2 and 4.

### Processes for Producing the Compounds of Formula (I)

The compounds according to the invention can be produced according to a process comprising, in general, a step of reacting a sulfur-containing compound with a compound of formula (IX)

X₁-Q₁-Z (IX)

and a compound of formula (X)

X₂-Q₂-A (X),

wherein
A, Z, Q₁ and Q₂ have the meanings defined above, and
X₁ and X₂ independently represent a Cl atom or an SH group.

Preferably, at least one among X₁ and X₂ is a Cl atom.

According to one particular embodiment, the compounds according to the invention of formula (I) with x=4 are produced by means of a process comprising the step of reacting sodium tetrasulfide with a compound of formula Cl-Q₁-Z and a compound of formula Cl-Q₂-A, wherein A, Z, Q₁ and Q₂ have the meanings defined above.

Preferably, A is a group of formula (VII):

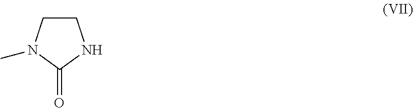

Preferably, Q₁ and Q₂ are independently a linear or branched, divalent C₁-C₁₀ hydrocarbon-based radical, more preferentially a linear divalent C₂ hydrocarbon-based radical. Preferably, Q₁ and Q₂ are identical.

The Z group is preferably the triethoxysilane group.

The sodium tetrasulfide can be produced for example by reacting sulfur with sodium sulfide anhydride; the latter can be produced by reacting sodium ethoxide with hydrogen sulfide. The sodium tetrasulfide is preferably produced in situ by adding sulfur to an ethanolic solution of sodium sulfide. The final nucleophilic substitution is preferably carried out in the solvent used for the production of the sodium tetrasulfide, that is to say ethanol. The temperature of this step can be between ambient temperature and the reflux temperature of the solvent. This step is preferably carried out at the reflux temperature of the solvent. The salt formed can be removed by filtration and the final product can be isolated by evaporating off the solvent.

This process can in particular be applied to the production of the compound of formula (VIII), according to the synthesis scheme below:

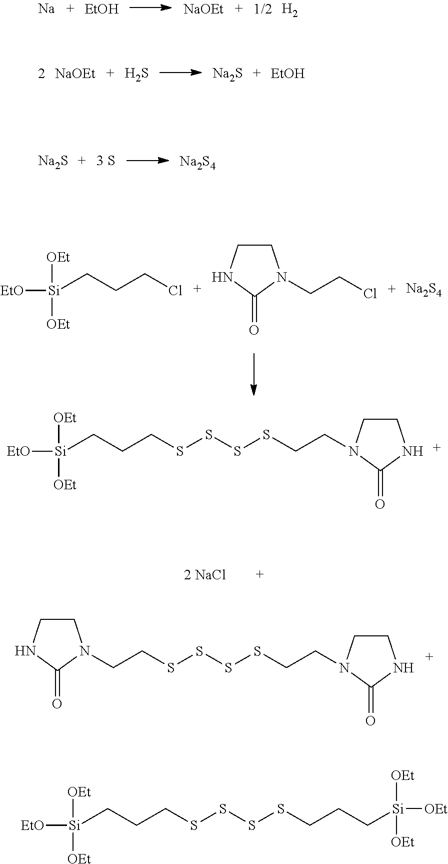

According to another particular embodiment, the compounds according to the invention of formula (I) with x ranging from 2 to 6, preferably from 2 to 5, and more particularly from 2 to 4, are produced by means of a process comprising a step of reacting sulfur with a compound of formula SH-Q₁-Z and a compound of formula Cl-Q₂-A, or else with a compound of formula Cl-Q₁-Z and a compound of formula SH-Q₂-A, wherein A, Z, Q₁ and Q₂ have the meanings defined above.

Preferably, A is a group of formula (VII):

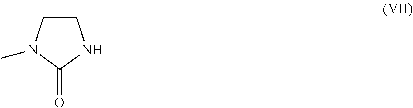

Preferably, Q₁ and Q₂ are independently a linear or branched, divalent C₁-C₁₀ hydrocarbon-based radical, more preferentially a linear divalent C₂ hydrocarbon-based radical. Preferably, Q₁ and Q₂ are identical.

The Z group is preferably the triethoxysilane group.

Preferably, the compound of formula SH-Q₁-Z is obtained by reacting a compound of formula Cl-Q₁-Z with sodium hydrosulfide NaSH; or the compound of formula SH-Q₂-A is obtained by reacting a compound of formula Cl-Q₂-A with sodium hydrosulfide NaSH.

This process preferably envisions reacting the mercaptan compound with a sodium alkoxide and sulfur in a solvent, then adding the chlorinated compound to the reaction mixture. The sodium alkoxide and the solvent are preferably sodium methoxide and methanol, or else sodium ethoxide and ethanol. The temperature of this step can be between ambient temperature and the reflux temperature of the solvent. The procedure is preferably carried out at the reflux of the solvent. The salt formed can be removed by filtration and the final product can be isolated by evaporating off the solvent.

The implementation of such a process generally makes it possible to obtain a mixture of polysulfide compounds having a distribution of the number of sulfur atoms ranging from 2 to 6, more particularly from 2 to 5, and principally from 2 to 4.

In particular, the compound of formula (VIII) with x ranging from 2 to 6, more particularly from 2 to 5, and principally from 2 to 4, can be produced according to the synthesis scheme below:

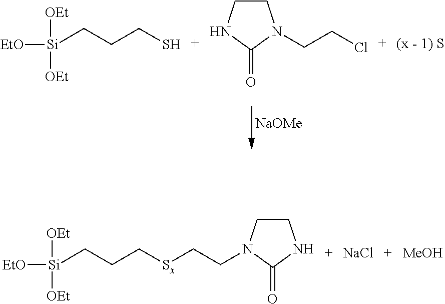

According to yet another embodiment, the compound of formula (I) can be produced by reacting, in the presence of a base, the symmetrical compounds of respective formulae (I′) and (I″):

A-Q₁-Sₓ-Q₂-A (I′)

Z-Q₁-Sₓ-Q₂-Z (I″)

wherein A, Z, Q₁, Q₂ and x have the same meaning as in formula (I).

In this process, A is preferably a group of formula (VII):

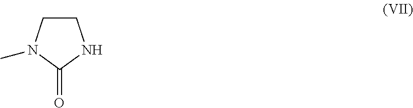

Preferably, Q₁ and Q₂ independently represent a divalent C₁-C₆ hydrocarbon-based radical, more preferentially a divalent C₂ hydrocarbon-based radical.

Preferably, the Z group is a triethoxysilane group.

In particular, this process makes it possible to produce the preferred compound of formula (VIII) according to the scheme below:

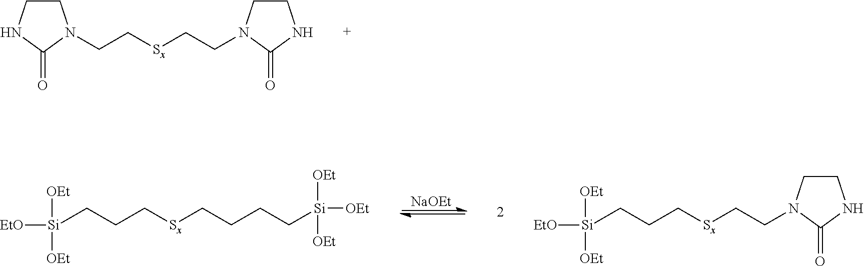

### Applications

The invention also relates to a rubber composition comprising at least one diene elastomer, a reinforcing filler, a chemical crosslinking agent and a modifying agent, optionally already grafted onto the elastomer, said modifying agent being a compound according to the invention as described above.

According to one embodiment, the rubber composition is a simple (non-crosslinked or non-vulcanized) mixture of the constituents above.

According to one embodiment, the rubber composition is a crosslinked or vulcanized mixture based on the mixture of constituents above.

In the present description, unless expressly indicated otherwise, all the percentages (%) indicated are by weight.

One of the components of the rubber composition according to the invention is a diene elastomer.

The diene elastomers can be categorized, in a known manner, in two categories, those termed essentially unsaturated and those termed essentially saturated. These two categories of diene elastomers can be envisioned in the context of the invention.

An essentially saturated diene elastomer has a low or very low content of moieties or units of diene origin (conjugated dienes) which is always less than 15% (by mol). Thus, for example, butyl rubbers or diene/alpha-olefin copolymers, such as EPDM (ethylene-propylene-diene monomer) come under the definition of essentially saturated diene elastomers

Conversely, the term “essentially unsaturated diene elastomer” is intended to mean a diene elastomer at least partly derived from conjugated diene elastomers, having a content of moieties or units of diene origin (conjugated dienes) which is greater than 15% (by mol). In the category of essentially unsaturated diene elastomers, the term “highly unsaturated diene elastomer” is intended to mean a diene elastomer having a content of moieties of diene origin (conjugated dienes) which is greater than 50% (by mol).

The term “diene elastomer which can be used in the invention” is intended to mean more particularly:

(a) any homopolymer obtained by polymerization of a conjugated diene monomer having from 4 to 12 carbon atoms;

(b) any copolymer obtained by copolymerization of one or more conjugated dienes with one another or with one or more vinyl aromatic compounds having from 8 to 20 carbon atoms;

(c) any ternary copolymer obtained by copolymerization of ethylene, of an α-olefin having from 3 to 6 carbon atoms with a nonconjugated diene monomer having from 6 to 12 carbon atoms, for instance the elastomers obtained from ethylene, from propylene with a nonconjugated diene monomer of the abovementioned type, such as in particular 1,4-hexadiene, ethylidene norbornene, dicyclopentadiene; such polymers are described in particular in documents WO 2004/035639A1 and US 2005/0239639A1;

(d) any copolymer of isobutene and of isoprene (butyl rubber), and also the halogenated versions, in particular chlorinated or brominated versions, of copolymers of this type.

The diene elastomers of the highly unsaturated type, in particular of type (a) or (b) above, are preferred.

Suitable conjugated dienes are in particular 1,3-butadiene, 2-methyl-1,3-butadiene, 2,3-di(C1-05)alkyl-1,3-butadienes, such as for example 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl aromatic compounds are for example styrene, ortho-, meta-, para-methylstyrene, the commercial “vinyl-toluene” mixture, para-tert-butylstyrene, methoxystyrenes, chlorostyrenes, vinylmesitylene, divinylbenzene and vinylnaphthalene.

The copolymers may contain between 99% and 20% by weight of diene units and between 1% and 80% by weight of vinyl aromatic units. The elastomers may have any microstructure, which depends on the polymerization conditions used, in particular on the presence or absence of a modifying and/or randomizing agent and on the amounts of randomising and/or modifying agent used. The elastomers may for example be block, random, sequenced or micro sequenced elastomers, and may be prepared in dispersion, in emulsion or in solution; they may be coupled and/or star-branched or else functionalized with a coupling and/or star-branching and/or functionalizing agent.

Particularly suitable are the diene elastomers chosen from the group consisting of polybutadienes (BR), synthetic polyisoprenes (IR), natural rubber (NR), butadiene copolymers, isoprene copolymers and blends of these elastomers. Such copolymers are more preferentially chosen from the group consisting of butadiene-styrene copolymers (SBR), isoprene-butadiene copolymers (BIR), isoprene-styrene copolymers (SIR), isoprene-butadiene-styrene copolymers (SBIR) and blends of such copolymers.

The rubber composition according to the invention also comprises at least the modifying agent which is a compound of formula (I) or one of the preferred variants thereof described above. The diene elastomer may be grafted by the modifying agent prior to its introduction into the rubber composition, or else may be grafted by reaction with the modifying agent during the production of the composition.

The rubber composition according to the invention may thus contain a single diene elastomer grafted by the modifying agent (either grafted prior to its introduction into the composition, or grafted by reaction with the modifying agent during the production of the composition), or a blend of several diene elastomers which are all grafted, or some of which are grafted and others not.

The other diene elastomer(s) used as a blend with the grafted elastomer according to the invention are conventional diene elastomers as described above, whether they are star-branched, coupled, functionalized or nonfunctionalized. These elastomers are then present in the matrix according to a content of between 0 and 60 phr (the limits of this range being excluded), preferentially according to a content ranging from more than 0 to 50 phr, even more preferentially from more than 0 to 30 phr.

In the case of a blend with at least one other diene elastomer, the weight fraction of grafted elastomer according to the invention in the elastomeric matrix is predominant and preferably greater than or equal to 50% by weight of the total weight of the matrix. The term “predominant weight fraction” refers according to the invention to the highest weight fraction of the blend.

It will be noted that, the lower the proportion of said supplementary elastomer(s) in the composition according to the invention, the greater the improvement in the properties of the rubber composition according to the invention.

The grafted diene elastomer(s) according to the invention can be used in combination with any type of synthetic elastomer other than a diene elastomer, or even with polymers other than elastomers, for example thermoplastic polymers.

According to one preferred embodiment, the modifying agent content ranges from 0.01 to 50 mol %, preferably from 0.01 mol % to 5 mol %.

In the remainder of the text, the term “modifying agent content” present in a rubber composition, expressed as molar percentage, is intended to mean the number of molecules of modifying agent present in the composition per hundred moieties of diene elastomer of the composition, whether they are, without distinction, diene or non-diene moieties.

For example, if the content of modifying agent on an SBR is 0.20 mol %, this means that there is a 0.20 moiety derived from modifying agent per 100 SBR styrene and butadiene moieties.

In the case where both an elastomer already grafted by the modifying agent and a diene elastomer not grafted by a modifying agent are used in the composition, the content of modifying agent represents the number of molecules of modifying agent grafted per 100 diene elastomer moieties, the number of moeties taking into account the two elastomers (grafted and nongrafted), assuming that other molecules of modifying agent not already grafted have not been added to the composition.

Another component of the rubber composition according to the invention is the reinforcing filler.

Use may be made of any type of reinforcing filler known for its capacities to reinforce a rubber composition, for example a reinforcing organic filler such as carbon black, a reinforcing inorganic filler such as silica, or else a blend of these two types of filler, in particular a blend of carbon black and silica. As other reinforcing fillers, use may also be made of cellulose-based fillers, talc, calcium carbonate, mica or wollastonite, glass or metal oxides or hydrates.

Preferably, a reinforcing inorganic filler is present.

All the carbon blacks are suitable carbon blacks, in particular those of the HAF, ISAF or SAF type. Use may also be made, depending on the intended applications, of the higher series blacks FF, FEF, GPF, SRF. The carbon blacks could for example already be incorporated into the diene elastomer in the form of a masterbatch, before or after grafting and preferably after grafting (see for example documents WO 97/36724 or WO 99/16600).

As examples of organic fillers other than carbon blacks, mention may be made of the functionalized polyvinyl aromatic organic fillers as described in documents WO 2006/069792 and WO 2006/069793.

In the present application, the term “reinforcing inorganic filler” should be understood to mean, by definition, any mineral or inorganic filler, as opposed to carbon black, capable of reinforcing by itself a rubber composition, without any means other than an intermediate coupling agent (for example, in the case of a rubber composition intended for the production of tires, a reinforcing inorganic filler is capable of replacing, in terms of its reinforcing function, a conventional tire-grade carbon black); such a filler is generally characterized, in a known manner, by the presence of hydroxyl groups at its surface.

The physical state in which the reinforcing inorganic filler is provided is unimportant, whether it is in powder, microbead, granule or bead form or any other suitable densified form. Of course, the term “reinforcing inorganic filler” is also intended to mean mixtures of various reinforcing inorganic fillers, in particular of highly dispersible siliceous and/or aluminous fillers as described hereinafter.

Suitable reinforcing inorganic fillers are in particular mineral fillers of the siliceous type, in particular silica (SiO₂), or of the aluminous type, in particular alumina (Al₂O₃). According to the invention, the content of reinforcing filler in the composition is between 30 and 150 phr, more preferentially between 50 and 120 phr. The optimum is different depending on the particular applications intended.

According to one particularly preferred embodiment, a mineral filler of siliceous type is present preferably in a content of from 30 to 150 phr.

According to one embodiment, the reinforcing filler comprises predominantly silica, the content of carbon black present in the composition preferably being between 2 and 20 phr.

According to another embodiment of the invention, the reinforcing filler comprises predominantly carbon black, or even exclusively consists of carbon black.

For coupling the reinforcing inorganic filler to the diene elastomer, it is possible to optionally include, in the composition, an at least bifunctional coupling agent (or bonding agent) intended to ensure a sufficient connection, of chemical and/or physical nature, between the inorganic filler (surface of its particles) and the diene elastomer, in particular bifunctional organosilanes or polyorganosiloxanes, for example bis(3-triethoxysilylpropyl) tetrasulfide.

Use may in particular be made, in a known manner, of the polysulfide-containing silanes, termed symmetrical or asymmetrical depending on their particular structure, as described for example in documents WO 03/002648 and WO 03/002649.

The content of coupling agent, when it is present, is preferentially between 4 and 12 phr, more preferentially between 3 and 8 phr.

Alternatively, the composition may be free of coupling agent, the coupling of the reinforcing inorganic filler to the diene elastomer being provided solely by the modifying agent described above.

As filler equivalent to the reinforcing inorganic filler described in the present paragraph, use may also be made of a reinforcing filler of another nature, in particular organic, provided that this reinforcing filler is covered with an inorganic layer such as silica, or else comprises, at its surface, functional sites, in particular hydroxyl sites, requiring coupling to establish the bond between the filler and the elastomer.

Another component of the rubber composition according to the invention is the chemical crosslinking agent.

The chemical crosslinking allows the formation of covalent bonds between the elastomer chains. The chemical crosslinking can be carried out in particular by means of a vulcanization system or else by means of peroxide compounds.

The vulcanization system per se is based on sulfur (or on a sulfur-donating agent) and on a primary vulcanization accelerator. Various known secondary vulcanization accelerators or vulcanization activators, such as zinc oxide, stearic acid or equivalent compounds, or guanidine derivatives (in particular diphenylguanidine) can be added to this basic vulcanization system.

The sulfur is used in a preferential content of between 0.5 and 12 phr, in particular between 1 and 10 phr. The primary vulcanization accelerator is used in a preferential content of between 0.5 and 10 phr, more preferentially of between 0.5 and 5.0 phr.

Any compound capable of acting as a vulcanization accelerator for diene elastomers in the presence of sulfur, in particular accelerators of thiazole type and also derivatives thereof, and accelerators of thiuram or zinc dithiocarbamate type, can be used as (primary or secondary) accelerator. A primary accelerator of the sulfenamide type is preferably used.

When the chemical crosslinking is carried out by means of one or more peroxide compounds, said peroxide compound(s) represent from 0.01 to 10 phr.

As peroxide compounds that can be used as chemical crosslinking system, mention may be made of acyl peroxides, for example benzoyl peroxide or p-chlorobenzoyl peroxide, ketone peroxides, for example methyl ethyl ketone peroxide, peroxyesters, for example tert-butyl peroxyacetate, tert-butyl peroxybenzoate and tert-butyl peroxyphthalate, alkyl peroxides, for example dicumyl peroxide, di-tert-butyl peroxybenzoate and 1,3-bis(tert-butyl peroxyisopropyl)benzene, hydroperoxides, for example tert-butyl hydroperoxide.

The rubber composition according to the invention may be a single-phase or polyphase mixture.

The rubber composition according to the invention may also comprise all or some of the usual additives normally used in rubber compositions, for instance petroleum fractions, solvents, plasticizers or extender oils, whether the latter are of aromatic or nonaromatic nature, pigments and/or dyes, tackifying resins, processing aids, lubricants, anti-radiation (anti-UV) additives, protective agents such as anti-ozone waxes (such as Ozone Wax C32 ST), chemical antiozonants, antioxidants (such as 6-para-phenylenediamine), anti-fatigue agents, reinforcing resins, methylene acceptors (for example novolac phenolic resin) or methylene donors (for example HMT or H3M) as described for example in document WO 02/10269, and also adhesion promoters (cobalt salts for example).

In particular, additives that can be added to the material according to the invention are especially:
lubricants, such as stearic acid and esters thereof, waxy esters, polyethylene waxes, paraffin or acrylic lubricants;
dyes;
mineral or organic pigments, such as those described in document “Plastics Additives and Modifiers Handbook, Section VIII, Colorants”, J. Edenbaum, published by Van Nostrand, p. 884-954. By way of example of pigments that can be used, mention may be made of carbon black, titanium dioxide, clay, metal particles or treated mica particles of the Iriodin® brand-name sold by Merck;
plasticizers;
heat and/or UV stabilizers, such as tin, lead, zinc, cadmium, barium or sodium stearates, including Thermolite® from Arkema;
co-stabilizers such as epoxidized natural oils;
antioxidants, for example phenolic, sulfur-containing or phosphate antioxidants;
antistatic agents;
fungicides and biocides;
swelling agents used to produce expanded articles, such as azodicarbonamides, azobisisobutyronitrile, diethyl azobisisobutyrate;
fire retardants, including antimony trioxide, zinc borate and brominated or chlorinated phosphate esters;
solvents; and
mixtures thereof.

Preferably, the rubber composition according to the invention comprises, as preferential nonaromatic or very weakly aromatic plasticizing agent, at least one compound chosen from the group consisting of naphthenic oils, paraffinic oils, MES oils, TDAE oils, glycerol esters (in particular trioleates), hydrocarbon-based plasticizing resins having a high glass transition temperature (Tg) of preferably greater than 30° C., and mixtures of such compounds.

The composition according to the invention may also contain, in addition to the coupling agents, reinforcing inorganic filler coupling activators or more generally processing aids capable, in a known manner, by virtue of an improvement in the dispersion of the inorganic filler in the rubber matrix and of a decrease in the viscosity of the compositions, of improving the processing capability thereof in the raw state.

The invention also relates to a tire comprising a rubber composition according to the invention or produced from a rubber composition according to the invention.

The invention also relates to a process for producing a rubber composition according to the invention, comprising one or more steps of thermomechanical kneading of the diene elastomer, the reinforcing filler, the chemical crosslinking agent and the modifying agent, and a step of extruding and calendering, or else of extrusion-blow molding, conventional molding, injection-molding, rotational molding or thermoforming.

The rubber composition according to the invention may especially be produced in a suitable mixer using two successive preparation phases: a phase of thermomechanical working or kneading (sometimes termed “non-productive phase”) at high temperature, up to a maximum temperature of between 130° C. and 200° C., preferably between 145° C. and 185° C., followed by a second phase (sometimes termed “productive phase”) at a lower temperature, typically less than 120° C., for example between 60° C. and 100° C.: this is a finishing phase during which the chemical crosslinking system is incorporated.

In general, all the basic constituents of the composition, with the exception of the chemical crosslinking system, namely the reinforcing filler(s), and the coupling agent where appropriate, are intimately incorporated, by kneading, into the diene elastomer(s) during the non-productive first phase, that is to say that at least these various basic constituents are introduced into the mixer and are thermomechanically kneaded in one or more steps until the maximum temperature of between 130° C. and 200° C., preferably of between 145° C. and 185° C., is reached.

According to a first embodiment of the invention, the diene elastomer is grafted with the modifying agent prior to the production of the rubber composition. Thus, in this case, it is the grafted diene elastomer which is introduced during the first phase, termed non-productive. Thus, according to this first embodiment of the process, said process comprises the following steps:
modifying the diene elastomer post-polymerization or in solution or in bulk by grafting of a modifying agent as described above;
incorporating, into the diene elastomer thus grafted with the modifying agent, the reinforcing filler and all the basic constituents of the composition, with the exception of the chemical crosslinking system, by thermomechanically kneading the whole mixture, in one or more steps, until a maximum temperature of between 130° C. and 200° C., preferably between 145° C. and 185° C., is reached;
cooling the whole mixture to a temperature of less than 100° C.;
then incorporating the chemical crosslinking agent;
kneading the whole mixture until a maximum temperature of less than 120° C. is reached;
extruding or calendering the rubber composition thus obtained.

According to a second embodiment of the invention, the grafting of the diene elastomer with the modifying agent is carried out concomitantly with the production of the rubber composition. In this case, both the not yet grafted diene elastomer and the modifying agent are introduced during the non-productive first phase. Preferentially, the reinforcing filler can then be subsequently added during this same non-productive phase in order to prevent any parasitic reaction with the modifying agent.

Thus, according to this second embodiment of the process, said process comprises the following steps:
incorporating, into the diene elastomer, a modifying agent as described above, at a temperature and for a period of time such that the grafting yield is preferably greater than 60%, more preferentially greater than 80%, and, preferably subsequently, the reinforcing filler, and also all the basic constituents of the composition, with the exception of the chemical crosslinking system, by thermomechanically kneading the whole mixture, one or more times, until a maximum temperature of between 130° C. and 200° C., preferably between 145° C. and 185° C., is reached;
cooling the whole mixture to a temperature of less than 100° C.;
then incorporating the chemical crosslinking agent;
kneading the whole mixture until a maximum temperature of less than 120° C. is reached;
extruding or calendering the rubber composition thus obtained.

The grafting of the modifying agent can be carried out in bulk, for example in an internal mixer or an external mixer such as a cylinder mixer. The grafting is then carried out either at an external-mixer or internal-mixer temperature of less than 60° C., followed by a grafting reaction step in a press or in an oven at temperatures ranging from 80° C. to 200° C., or at an external-mixer or internal-mixture temperature greater than 60° C. without subsequent heat treatment.

The compositions thus obtained are calendered either in the form of plates (from 2 to 3 mm thick) or of thin sheets of rubber for measurement of their physical or mechanical properties, or in the form of profiled parts that can be used directly, after cutting up and/or assembly to the desired dimensions, for example as finished or semi-finished products, in particular as semi-finished products for tires, in particular as tire treads.

The invention makes it possible in particular to obtain leaktight seals, thermal or acoustic insulators, cables, sheaths, footwear soles, packagings, coatings (paints, films, cosmetic products), patches (cosmetic or dermopharmaceutical), or other systems for trapping and releasing active agents, dressings, elastic clamp collars, vacuum pipes, pipes and flexible tubing for the transportation of fluids, and, in general, parts which must have an elastic behavior, while at the same time having good flexibility, and good fatigue resistance, impact strength and resistance to tearing. These materials may also form part of adhesive or cosmetic compositions or ink, varnish or paint formulations.

### Modified Polymers

A subject of the invention is also a modified polymer obtained by grafting a compound according to the invention of formula (I) or corresponding to one of the preferred embodiments.

Preferably, the polymer contains at least one unsaturation or double bond capable of reacting with the compound according to the invention.

Preferably, the polymers in question are diene elastomers, as defined above.

According to the invention, the polymer having at least one unsaturation or double bond is modified by grafting a compound of formula (I) as defined above, also called modifying agent.

According to a preferred embodiment, the content of modifying agent ranges from 0.01 to 50 mol %, preferably from 0.01 mol % to 5 mol %.

The invention also relates to a process for producing a modified polymer, comprising a step of grafting a compound according to the invention as defined above onto a polymer comprising at least one unsaturation.

The accepted mechanism for the grafting is homolytic cleavage of the polysulfide, followed by radical addition of S° radicals on the double bonds of the polymer.

The grafting of the modifying agent can be carried out in bulk, for example in an internal mixer or an external mixer such as a cylinder mixer, or in solution. The grafting process may be carried out in solution in continuous or batchwise mode. The polymer thus modified can be separated from its solution by any type of means known by those skilled in the art and in particular by a water-vapor bubbling operation.

For example, the grafting step can be carried out in the molten state, for example in an extruder or an internal mixer at a temperature which can range from 50° C. to 300° C., and preferably from 200 to 280° C. The modifying agent can be mixed with the polymer alone, or by means of an additive allowing impregnation of the solid polymer grains with the premelted modifying agent. The solid mixture before introduction into the extruder or the mixer can be made more homogeneous by refrigeration so as to solidify the modifying agent. It is also possible to meter the latter into the extruder or the mixer after the polymer to be grafted has begun to melt. The time at the grafting temperature can range from 30 seconds to 5 hours. The modifying agent can be introduced into the extruder in the form of a masterbatch in a polymer which, preferably, can be the polymer to be grafted. According to this method of introduction, the masterbatch may comprise up to 30% by weight of the modifying agent; the masterbatch is subsequently diluted in the polymer to be grafted during the grafting operation.

According to another possibility, the grafting can be carried out by solvent-phase reaction, for example in anhydrous chloroform. In this case (anhydrous chloroform), the reaction temperature can range from 5° C. to 75° C., for a period of time ranging from a few minutes to one day and at concentrations of polymer before grafting of between 1% and 50% by weight, relative to the total weight of the solution.

The number of associative groups introduced onto the polymer is adjusted so as to obtain materials which have good dimensional stability and good mechanical properties by virtue of the permanent chemical crosslinking, while at the same time being easier to process and having particular properties, such as for example mechanical properties which can be adjusted, owing to the introduction of a different method of crosslinking (non-permanent) which are capable of evolving as a function of the parameters of the environment in which said materials are used, such as, for example, the characteristic stress temperature or time.

For example, the average number of associative groups per polymer chain can be between 1 and 200.

Thus, the ratio between the percentage of permanent covalent bond crosslinking bridges and the percentage of noncovalent bond crosslinking bridges is advantageously between 99/1 and 1/99, and preferably between 90/10 and 20/80.

### EXAMPLES

The following examples illustrate the invention without limiting it.

### Example 1—Synthesis of the Compound of Formula (VIII) from Chlorinated Derivatives

1-(2-Chloroethyl)imidazolidin-2-one is prepared according to example 1b of document WO 2012/007684.

15 g of sodium (0.65 mol) are introduced into a 500 ml glass reactor equipped with a reflux condenser and flushed with nitrogen. 200 g of ethanol are slowly added, then the mixture is left at the reflux of ethanol for approximately 1 h until the sodium has entirely dissolved.

The mixture is cooled to 40° C., then 11.1 g of H₂S (0.33 mol) are introduced into the reaction mixture via a diffuser over a period of approximately 1 hour.

At the end of the addition of the H2S, the mixture is cooled to 25° C., and 31.4 g of sulfur (0.98 mol) are added. The mixture is allowed to react for 15 minutes, then nitrogen is bubbled into the reaction mixture before heating to the reflux of ethanol.

A mixture composed of 48.3 g of 1-(2-chloroethyl)imidazolidin-2-one (0.33 mol) and 78.3 g of (3-chloropropyl)triethoxysilane (0.33 mol) is then added over a period of 1 hour, then the mixture is left to react for 2 hours at reflux.

The reaction mixture is cooled to ambient temperature then filtered. The precipitate is washed with 100 g of ethanol. The filtrates are brought together and evaporated under vacuum. 132 g of a mixture of polysulfides are obtained (91% yield). The final product is analyzed by NMR and HPLC. The analysis shows that said product is a mixture of symmetrical and asymmetrical polysulfides with sulfur ranks of 2 to 6. The compound of formula (VIII), which is in the majority, is one of these products.

### Example 2—Synthesis of the Compound of Formula (VIII) from a Chlorinated Derivative and a Mercaptan Derivative

1-(2-Chloroethyl)imidazolidin-2-one is prepared according to example 1b of document WO 2012/007684.

Anhydrous sodium ethoxide (0.4 mol) in the form of a solution at 10% by weight in ethanol (272 g of solution) and then 102 g of 3-mercaptopropyltriethoxysilane (0.43 mol) and 41 g of powdered sulfur (1.28 mol) are introduced into a 500 ml glass reactor equipped with a reflux condenser and flushed with nitrogen. The reaction mixture is stirred at reflux for 16 hours and then 63 g of 1-(2-chloroethyl)imidazolidin-2-one (0.43 mol) are slowly added. The mixture is left at reflux for 6 hours. The reaction mixture is cooled to ambient temperature then filtered. The filtrate is concentrated under reduced pressure in order to evaporate off the solvent. The final product is analyzed by NMR and HPLC. The analysis shows that said product is a mixture of polysulfides. The compound of formula (VIII), which is in the majority, is one of these products.

1-26. (canceled)

27. A compound of formula (I)
Z-Q₁-Sₓ-Q₂-A (I)
wherein:
A represents an associative group comprising at least one nitrogen atom,
Q₁ and Q₂ represent, independently of one another, a bonding group,
x is an integer ranging from 2 to 6, and
Z represents the group: 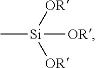
wherein each R′ independently represents an alkyl group comprising from 1 to 4 carbon atoms.

28. The compound as claimed in claim 27, wherein A is selected from the group consisting of imidazolidinone, triazolyl, ureyl, bisureyl and ureidopyrimidyl groups.

29. The compound as claimed in claim 27, wherein A corresponds to one of formulae (II) to (VI) below: 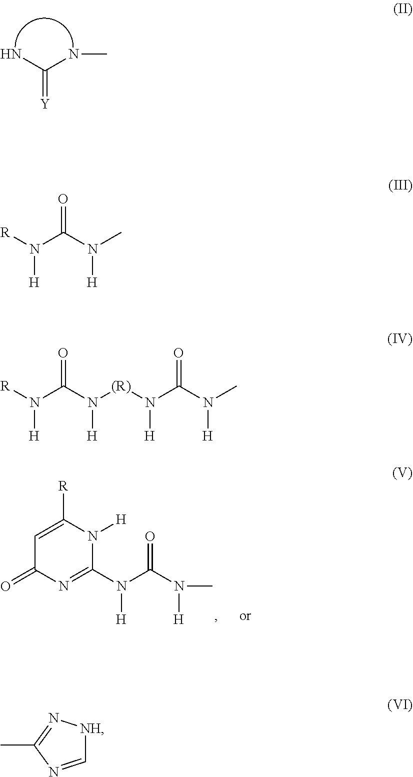
where:
R denotes a hydrocarbon-based group, and
Y denotes an oxygen or sulfur atom.

30. The compound as claimed in claim 27, wherein A is a group of formula (VII):

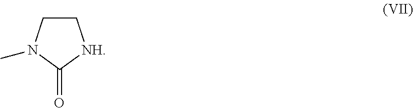

31. The compound as claimed in claim 27, wherein Q₁ and Q₂ are independently a linear or branched, substituted or unsubstituted, divalent C₁-C₂₄, hydrocarbon-based radical.

32. The compound as claimed in claim 27, wherein x is equal to 4.

33. The compound as claimed in claim 27, wherein all R′ are identical in the Z group.

34. The compound of claim 27, having formula (VIII) below:

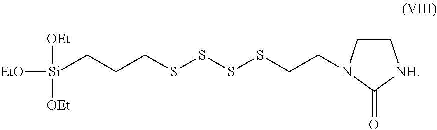 [SMILES: CCO[Si](CCCSSSSCCN1CCNC1=O)(OCC)OCC]

35. A mixture of different compounds of formula (I)
Z-Q₁-Sₓ-Q₂-A (I)
wherein:
A represents an associative group comprising at least one nitrogen atom,
Q₁ and Q₂ represent, independently of one another, a bonding group,
x is an integer ranging from 2 to 6, and
Z represents the group: 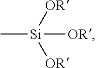
wherein each R′ independently represents an alkyl group comprising from 1 to 4 carbon atoms; and
the compounds having different values of x and otherwise being identical, wherein x has an average value of between 2 and 6.

36. A composition comprising the compound of formula (I) as claimed in claim 27, and also compounds of formulae (I′) and (I″) below:
A-Q₁-Sₓ-Q₂-A (I′)
Z-Q₁-Sₓ-Q₂-Z (I″),
wherein A, Z, Q₁, Q₂ and x have the same meaning as in formula (I).

37. A process for producing the compound of formula (I) as claimed in claim 27, comprising a step of reacting a sulfur-containing compound with a compound of formula (IX)
X₁-Q₁-Z (IX)
and a compound of formula (X)
X₂-Q₂-A (X),
wherein
A, Z, Q₁ and Q₂ have the meanings defined in claim 27, and
X₁ and X₂ independently represent a Cl atom or an SH group.

38. The process as claimed in claim 37, wherein X₁ and X₂ each represent a Cl atom.

39. The process as claimed in claim 38, wherein the sulfur-containing compound is sodium tetrasulfide, and the compound prepared being of formula (I) with x=4.

40. The process as claimed in claim 37, wherein the sulfur-containing compound is sulfur, X₁ is an SH group and X₂ is a Cl group or vice versa.

41. A process for producing the compound of formula (I) as claimed in claim 27, comprising a step of reacting, in the presence of a base, a compound of formula (I′) with a compound of formula (I″):
A-Q₁-Sₓ-Q₂-A (I′)
Z-Q₁-Sₓ-Q₂-Z (I″)
wherein A, Z, Q₁, Q₂ and x have the same meaning as in formula (I).

42. The process as claimed in claim 41, wherein:
A is a group of formula (VII): 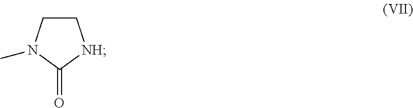
and/or
Q₁ and Q₂ independently represent a divalent C₁-C₆ hydrocarbon-based radical l; and/or
all the R′ groups in the Z group are ethyl groups; and/or
the base is a sodium alkoxide.

43. A rubber composition comprising at least one diene elastomer, a reinforcing filler, a chemical crosslinking agent and a modifying agent, said modifying agent being a compound of formula (I) as claimed in claim 27.

44. The composition as claimed in claim 43, wherein the diene elastomer comprises an essentially unsaturated diene elastomer comprising natural rubber, synthetic polyisoprenes, polybutadienes, butadiene copolymers, isoprene copolymers or blends thereof; and/or comprises an essentially saturated elastomer comprising butyl rubbers, diene/alpha-olefin copolymers such as EPDM, and blends thereof.

45. The composition as claimed in claim 43, wherein the chemical crosslinking agent comprises from 0.5 to 12 phr of sulfur, or from 0.01 to 10 phr of one or more peroxide compounds.

46. The composition as claimed in claim 43, wherein the content of modifying agent ranges from 0.01 to 50 mol %.

47. A process for producing a rubber composition as claimed in claim 43, comprising one or more steps of thermomechanical kneading the diene elastomer, the reinforcing filler, the chemical crosslinking agent and the modifying agent, and a step of extruding and calendering.

48. An item produced entirely or partly with the rubber composition as claimed in claim 43, wherein the item is selected from the group consisting of leaktight seals, thermal or acoustic insulators, cables, sheaths, footwear soles, packagings, coatings (paints, films, cosmetic products), patches (cosmetic or dermopharmaceutical), other systems for trapping and releasing active agents, dressings, elastic clamp collars, vacuum pipes, and pipes and flexible tubing for the transportation of fluids.

49. A tire comprising the rubber composition as claimed in claim 43.

50. A modified polymer obtained by grafting of a compound of formula (I) as claimed in claim 27.

51. The modified polymer as claimed in claim 50, wherein the polymer is an essentially unsaturated diene elastomer chosen from natural rubber, synthetic polyisoprenes, polybutadienes, butadiene copolymers, isoprene copolymers and blends of these elastomers, or an essentially saturated elastomer chosen from butyl rubbers, diene/alpha-olefin copolymers such as EPDM, and blends thereof.

52. A process for producing a modified polymer, comprising a step of grafting a compound of formula (I) as claimed in claim 27 onto a polymer comprising at least one unsaturation.
